(19) United States
(12) Patent Application Publication
(10) Pub. No.: US 2026/0129579 A1
(43) Pub. Date: May 7, 2026

(54) SMALL DATA TRANSMISSION WITH LOW-POWER WAKE-UP SIGNAL

(71) Applicant: Nokia Technologies Oy, Espoo (FI)

(72) Inventors: Jussi-Pekka KOSKINEN, Oulu (FI); Jorma Johannes KAIKKONEN, Oulu (FI); Jani-Pekka KAINULAINEN, Cambridge (GB)

(21) Appl. No.: 18/940,180

(22) Filed: Nov. 7, 2024

(51) Int. Cl. H04W 52/02; H04B 17/318; H04W 56/00; H04W 76/20

(52) U.S. Cl. CPC H04W 52/0235; H04B 17/328; H04W 56/0015; H04W 76/20

(57) ABSTRACT

Example embodiments of the present disclosure are directed to mall data transmission (SDT) with low-power wake-up signal (LP-WUS). A method comprises disabling, during monitoring a low power wake up signal from a second apparatus, evaluation of a signal quality threshold for a small data transmission, SDT to the second apparatus; in response to exiting the monitoring of the low power wake up signal, enabling one or more measurements on a reference signal from the second apparatus; evaluating a reference signal quality of the reference signal based on the one or more measurements and a signal quality threshold; and based on that the reference signal quality meets a condition associated with the signal quality threshold, initiating the SDT to the second apparatus.

### FIELD

Various example embodiments of the present disclosure generally relate to the field of telecommunication and in particular, to methods, devices, apparatuses and computer readable storage medium for small data transmission (SDT) with low-power wake-up signal (LP-WUS).

### BACKGROUND

The study of LP-WUS and low power wake-up receiver (LP-WUR, also shorted as LR) in 5G new radio (NR) may enable more power efficient operation on user equipment (UE) and more optimal resource allocation for network. The UE can be in a sleep mode or even powered off for power saving and be activated only upon the reception of the LP-WUS from the network. Low-power synchronization signal (LP-SS) can be used to enable the LP-WUR to maintain synchronization to the cell.

### SUMMARY

In a first aspect of the present disclosure, there is provided a first apparatus. The first apparatus comprises at least one processor; and at least one memory storing instructions that, when executed by the at least one processor, cause the first apparatus at least to: perform, during monitoring a low power wake up signal from a second apparatus, one or more measurements on a reference signal from the second apparatus, wherein the reference signal is based on a synchronization signal; evaluate a reference signal quality of the reference signal based on the one or more measurements and a first signal quality threshold; and at least based on that the reference signal quality meets a condition associated with the first signal quality threshold, initiate a small data transmission, SDT, to the second apparatus.

In a second aspect of the present disclosure, there is provided a second apparatus. The second apparatus comprises at least one processor; and at least one memory storing instructions that, when executed by the at least one processor, cause the second apparatus at least to: transmit, to a first apparatus, a reference signal that is based on a synchronization signal; and receive, from the first apparatus, a small data transmission, SDT, wherein the SDT is initiated at least based on that a reference signal quality obtained from one or more measurement on the reference signal meets a condition associated with a first quality threshold.

In a third aspect of the present disclosure, there is provided a method. The method comprises: performing, during monitoring a low power wake up signal from a second apparatus, one or more measurements on a reference signal from the second apparatus, wherein the reference signal is based on a synchronization signal; evaluating a reference signal quality of the reference signal based on the one or more measurements and a first signal quality threshold; and at least based on that the reference signal quality meets a condition associated with the first signal quality threshold, initiate a small data transmission, SDT, to the second apparatus.

In a fourth aspect of the present disclosure, there is provided a method. The method comprises: transmitting, to a first apparatus, a reference signal that is based on a synchronization signal; and receiving, from the first apparatus, a small data transmission, SDT, wherein the SDT is initiated at least based on that a reference signal quality obtained from one or more measurement on the reference signal meets a condition associated with a first quality threshold.

In a fifth aspect of the present disclosure, there is provided a first apparatus. The first apparatus comprises means for performing, during monitoring a low power wake up signal from a second apparatus, one or more measurements on a reference signal from the second apparatus, wherein the reference signal is based on a synchronization signal; means for evaluating a reference signal quality of the reference signal based on the one or more measurements and a first signal quality threshold; and at least based on that the reference signal quality meets a condition associated with the first signal quality threshold, initiate a small data transmission, SDT, to the second apparatus.

In a sixth aspect of the present disclosure, there is provided a second apparatus. The second apparatus comprises means for transmitting, to a first apparatus, a reference signal that is based on a synchronization signal; and means for receiving, from the first apparatus, a small data transmission, SDT, wherein the SDT is initiated at least based on that a reference signal quality obtained from one or more measurement on the reference signal meets a condition associated with a first quality threshold.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

In a ninth aspect of the present disclosure, there is provided a first apparatus. The first apparatus comprises at least one processor; and at least one memory storing instructions that, when executed by the at least one processor, cause the first apparatus at least to: upon exiting monitoring on a low power wake up signal, perform one or more measurements on a reference signal from a second apparatus; evaluate a reference signal quality of the reference signal based on the one or more measurements and a second signal quality threshold; and based on that the reference signal quality meets a condition associated with the second signal quality threshold, initiate a small data transmission, SDT, to the second apparatus.

In a tenth aspect of the present disclosure, there is provided a second apparatus. The second apparatus comprises at least one processor; and at least one memory storing instructions that, when executed by the at least one processor, cause the second apparatus at least to: transmit a reference signal to a first apparatus; and receive, from the first apparatus, a small data transmission, SDT, wherein the SDT is initiated based on that a reference signal quality obtained from one or more measurement on the reference signal meets a condition associated with a second quality threshold, and the one or more measurements are performed upon existing monitoring of a low power wake up.

In an eleventh aspect of the present disclosure, there is provided a method. The method comprises: upon exiting monitoring on a low power wake up signal, perform one or more measurements on a reference signal from a second apparatus; evaluating a reference signal quality of the reference signal based on the one or more measurements and a second signal quality threshold; and based on that the reference signal quality meets a condition associated with the second signal quality threshold, initiating a small data transmission, SDT, to the second apparatus.

In a twelfth aspect of the present disclosure, there is provided a method. The method comprises: transmitting a reference signal to a first apparatus; and receiving, from the first apparatus, a small data transmission, SDT, wherein the SDT is initiated based on that a reference signal quality obtained from one or more measurement on the reference signal meets a condition associated with a second quality threshold, and the one or more measurements are performed upon existing monitoring of a low power wake up.

In a thirteenth aspect of the present disclosure, there is provided a first apparatus. The first apparatus comprises means for upon exiting monitoring on a low power wake up signal, perform one or more measurements on a reference signal from a second apparatus; means for evaluating a reference signal quality of the reference signal based on the one or more measurements and a second signal quality threshold; and means for based on that the reference signal quality meets a condition associated with the second signal quality threshold, initiating a small data transmission, SDT, to the second apparatus.

In a fourteenth aspect of the present disclosure, there is provided a second apparatus. The second apparatus comprises means for transmitting a reference signal to a first apparatus; and means for receiving, from the first apparatus, a small data transmission, SDT, wherein the SDT is initiated based on that a reference signal quality obtained from one or more measurement on the reference signal meets a condition associated with a second quality threshold, and the one or more measurements are performed upon existing monitoring of a low power wake up.

In a fifteenth aspect of the present disclosure, there is provided a computer readable medium. The computer readable medium comprises instructions stored thereon for causing an apparatus to perform at least the method according to the eleventh aspect.

In a sixteenth aspect of the present disclosure, there is provided a computer readable medium. The computer readable medium comprises instructions stored thereon for causing an apparatus to perform at least the method according to the twelfth aspect.

In a seventeenth aspect of the present disclosure, there is provided a first apparatus. The first apparatus comprises at least one processor; and at least one memory storing instructions that, when executed by the at least one processor, cause the first apparatus at least to: disable, during monitoring a low power wake up signal from a second apparatus, evaluation of a signal quality threshold for a small data transmission, SDT to the second apparatus; in response to exiting the monitoring of the low power wake up signal, enable one or more measurements on a reference signal from the second apparatus; evaluate a reference signal quality of the reference signal based on the one or more measurements and a signal quality threshold; and based on that the reference signal quality meets a condition associated with the signal quality threshold, initiate the SDT to the second apparatus

In an eighteenth aspect of the present disclosure, there is provided a method. The method comprises: disabling, during monitoring a low power wake up signal from a second apparatus, evaluation of a signal quality threshold for a small data transmission, SDT to the second apparatus; in response to exiting the monitoring of the low power wake up signal, enabling one or more measurements on a reference signal from the second apparatus; evaluating a reference signal quality of the reference signal based on the one or more measurements and a signal quality threshold; and based on that the reference signal quality meets a condition associated with the signal quality threshold, initiating the SDT to the second apparatus

In a nineteenth aspect of the present disclosure, there is provided a first apparatus. The first apparatus comprises means for disabling, during monitoring a low power wake up signal from a second apparatus, evaluation of a signal quality threshold for a small data transmission, SDT to the second apparatus; means for in response to exiting the monitoring of the low power wake up signal, enabling one or more measurements on a reference signal from the second apparatus; means for evaluating a reference signal quality of the reference signal based on the one or more measurements and a signal quality threshold; and means for based on that the reference signal quality meets a condition associated with the signal quality threshold, initiating the SDT to the second apparatus

In a twentieth aspect of the present disclosure, there is provided a computer readable medium. The computer readable medium comprises instructions stored thereon for causing an apparatus to perform at least the method according to the eighteenth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates example UE operations with an LP-WUR;

FIG. 3 illustrates an example signalling chart for SDT transmission according to some example embodiments of the present disclosure;

FIG. 4A illustrates a flowchart of a method implemented at a first apparatus according to some example embodiments of the present disclosure;

FIG. 4B illustrates a flowchart of a method implemented at a second apparatus according to some example embodiments of the present disclosure;

FIG. 5 illustrates another example signalling chart for SDT transmission according to some example embodiments of the present disclosure;

FIG. 6A illustrates a flowchart of a method implemented at a first apparatus according to some example embodiments of the present disclosure;

FIG. 6B illustrates a flowchart of a method implemented at a second apparatus according to some example embodiments of the present disclosure;

FIG. 7 illustrates a further example signalling chart for SDT transmission according to some example embodiments of the present disclosure;

FIG. 8 illustrates a flowchart of a method implemented at a first apparatus according to some example embodiments of the present disclosure;

FIG. 9 illustrates a simplified block diagram of a device that is suitable for implementing example embodiments of the present disclosure; and

FIG. 10 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It should be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low-power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” (RB), “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

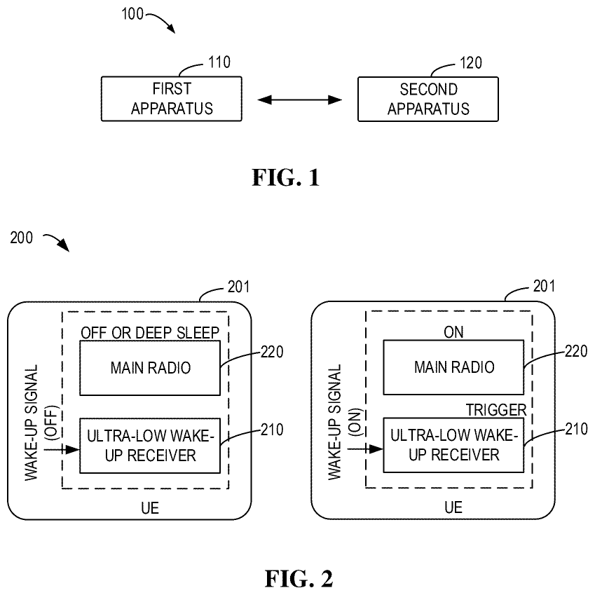

Principle and implementations of the present disclosure will be described in detail below with reference to FIGS. 1-10.

FIG. 1 illustrates an example communication environment 100 in which example embodiments of the present disclosure can be implemented. In the communication environment 100, a first apparatus 110 and a second apparatus 120 can communicate with each other. In some example embodiments, the first apparatus 110 may comprise a terminal device (for example, a UE), and the second apparatus 120 may comprise a network device (for example, a gNB).

The first apparatus 110 may include a main receiver and a low power receiver, which are not shown in FIG. 1. The low power receiver may have a respectively small power, for example, smaller than that of the main receiver. The main receiver may have a sleep mode, an LP-WUS mode, or powered-off mode for power saving. The low power receiver may wake up the main receiver.

It is to be understood that the number of first apparatus 110 and second apparatus 120 shown in FIG. 1 is given for the purpose of illustration without suggesting any limitations. The communication environment 100 may include any suitable number of first apparatus 110 and second apparatus 120.

In the following, for the purpose of illustration, some example embodiments are described with the first apparatus 110 operating as a terminal device and the second apparatus 120 operating as a network device. However, in some example embodiments, operations described in connection with a terminal device may be implemented at a network device or other device, and operations described in connection with a network device may be implemented at a terminal device or other device.

In some example embodiments, if the first apparatus 110 is a terminal device or included in a terminal device and the second apparatus 120 is a network device or is included in a network device, a link from the second apparatus 120 to the first apparatus 110 is referred to as a downlink (DL), and a link from the first apparatus 110 to the second apparatus 120 is referred to as an uplink (UL). In DL, the second apparatus 120 is a transmitting (TX) device (or a transmitter) and the first apparatus 110 is a receiving (RX) device (or a receiver). In UL, the first apparatus 110 is a TX device (or a transmitter) and the second apparatus 120 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

5G systems are designed and developed targeting both mobile telephony and vertical use cases. Besides latency, reliability, and availability, UE energy efficiency is also critical to 5G. Currently, 5G devices may have to be recharged per week or day, depending on individual's usage time. In general, 5G devices consume tens of milliwatts in radio resource control (RRC) idle/inactive state and hundreds of milliwatts in RRC connected state. Designs to prolong battery life are a necessity for improving energy efficiency as well as for better user experience.

Energy efficiency is even more critical for UEs without a continuous energy source, e.g., UEs using small rechargeable and single coin cell batteries. Among vertical use cases, sensors and actuators are deployed extensively for monitoring, measuring, charging, etc. Generally, their batteries are not rechargeable and expected to last at least a few years as described in TR38.875. Wearables include smart watches, rings, eHealth related devices, and medical monitoring devices. With typical battery capacity, it is challenging to sustain up to 1-2 weeks as required.

Power consumption depends on the configured length of wake-up periods, e.g., paging cycle. To meet the battery life requirements above, long extended discontinuous reception (eDRX) cycle may be used, resulting in high latency, which is not suitable for such services with requirements of both long battery life and low latency. For example, in fire detection and extinguishment use cases, fire shutters should be closed, and fire sprinklers should be turned on by the actuators within 1 to 2 seconds from the time the fire is detected by sensors. Long eDRX cycles cannot meet delay requirements. eDRX is apparently not suitable for latency-critical use cases.

The Release (Rel)-18 study item (SI) for “Study on LP-WUS and receiver for NR” includes some investigations. For example, the LP-WUS and receiver are studied, including power saving benefit, coverage, system overhead impact, network energy impact and other related aspects. The receiver architecture for LP-WURs is studied, and analysis for power consumption, noise figures and the like are provided. The investigations further relate to L1 design and procedure changes needed to support the LP-WUS and evaluations for the link performances, higher layer protocol changes needed to support the LP-WUSs, and related impacts.

In RRC IDLE/INACTIVE modes, it's observed that significant UE power saving gain (up to more than 90%) is obtained by using LP-WUS/WUR to trigger UE main radio (MR) paging monitoring compared with existing idle-discontinuous reception (I-DRX) operation with and without paging early indication (PEI), if sufficient relaxation to MR radio resource management (RRM) measurement is applied. Further, compared with existing eDRX operation, significant paging latency reduction and moderate UE power saving gain is observed, if LP-WUS monitoring and the corresponding paging monitoring after MR wake-up is not restricted within existing paging time window (PTW) of eDRX.

Compared with existing UE power saving techniques, in RRC CONNECTED mode, it's observed that moderate UE power saving gain (up to more than 10%) is obtained with marginal impact to capacity by using LP-WUS/WUR to trigger UE MR physical downlink control channel (PDCCH) monitoring, across different types of extended reality (XR) traffic and system load scenarios. It's also observed that significant UE power saving gain (up to more than 60%) and moderate UPT improvement (up to more than 10%) is obtained for file transfer protocol (FTP) and instant messaging (IM) traffic, when the UE MR enters a deep sleep state during LR LP-WUS monitoring. Furthermore, Rel-18 study verified the feasibility of serving cell RRM measurement offloading from UE MR to LP-WUR by reasonable evaluation methodology. RAN4 also identified some issues which could be further discussed in work item (WI) phase.

Based on the SI outcome, it is proposed to specify LP-WUS/WUR in Rel-19. Some of the objectives of the WI are as follows.

One objective is to specify an LP-WUS design commonly applicable to both IDLE/INACTIVE and CONNECTED modes, including that on-off keying (OOK) (OOK-1 and/or OOK-4) based LP-WUS with overlaid orthogonal frequency division multiplexing (OFDM) sequence(s) over OOK symbol is specified, and at least duty-cycled monitoring of LP-WUS is supported. The LP-WUS design should ensure that for IDLE/INACTIVE operation, the same information is delivered irrespective of LP-WUR type. The OFDM sequence can carry information.

For IDLE/INACTIVE modes, the objectives include the following. Procedure and configuration of LP-WUS indicating paging monitoring triggered by LP-WUS are specified, including at least configuration, sub-grouping and entry/exit condition for LP-WUS monitoring (RAN2, RAN1, RAN3, RAN4). LP-SS with periodicity with Yms for LP-WUR, for synchronization and/or RRM for serving cells. Specifically, LP-SS is based on OOK-1 and/or OOK-4 waveform with or without overlaid OFDM sequences. Further down selection between with and without overlaid OFDM sequences is to be done within WI. It is noted that LP-WUR that can receive existing primary synchronization signal (PSS)/secondary synchronization signal (SSS), existing PSS/SSS can be used for synchronization and RRM instead of LP-SS. Y will be decided within WI. 320 ms is the starting point. In addition, RRM relaxation of UE MR for both serving and neighbor cell measurements, and UE serving cell RRM measurement offloaded from MR to LP-WUR are further specified, including the necessary conditions.

For CONNECTED mode, the objectives include that procedures to allow UE MR PDCCH monitoring triggered by LP-WUS including activation and deactivation procedure of LP-WUS monitoring are specified, and it is checked in RAN #105 for potential TU adjustment in RAN2. Note that, in CONNECTED mode, UE MR ultra-deep sleep is not considered, and UE RRM/radio link management (RLM)/beam failure detection (BFD)/channel state information (CSI) measurements are performed by MR.

Furthermore, the objective includes that the necessary core requirement(s) to support the feature is specified. This objective is to be further refined. Note that the target coverage of LP-WUS and LP-SS should be the coverage of physical uplink shared channel (PUSCH) for message3 and the optimization of LP-WUS signal design for idle/inactive mode is prioritized over the optimization for connected mode.

Small Data Transmission (SDT) is a procedure allowing data and/or signalling transmission while remaining in RRC_INACTIVE state (i.e. without transitioning to RRC_CONNECTED state). SDT is enabled on a radio bearer basis and can be initiated either by the UE in case of Mobile Originated SDT (MO-SDT) or by the network in case of Mobile Terminated SDT (MT-SDT). MO-SDT is initiated by the UE only if less than or equal to a configured amount of UL data awaits transmission across all radio bearers for which SDT is enabled, the DL reference signal received power (RSRP) is above a configured threshold, and a valid SDT resource is available. MT-SDT is initiated by the network with an indication to the UE in a paging message when DL data awaits transmission for radio bearers configured for SDT; based on the indication, the UE initiates the MT-SDT only if the DL RSRP is above a configured threshold as specified in clause 5.27.1 of TS 38.321 [6]. When MT-SDT is initiated by the UE, a resume cause indicating MT-SDT is included in the RRCResumeRequest/RRCResumeRequest1. The maximum duration the SDT procedure can last is dictated by an SDT failure detection timer that is configured by the network. Network can enable MO-SDT, MT-SDT, or both in a cell.

SDT procedure is initiated with either transmission over random access channel (RACH) (configured via system information) or over Type 1 configuration grant (CG) resources (configured via dedicated signalling in RRCRelease). The SDT resources can be configured on the initial bandwidth part (BWP) for both RACH and CG. RACH and CG resources for SDT can be configured on either or both of normal uplink (NUL) and supplementary uplink (SUL) carriers. The CG resources for SDT are valid only within the primary cell (PCell) of the UE when the RRCRelease with suspended indication is received. CG resources are associated with one or multiple synchronization signal blocks (SSBs). For RACH, the network can configure 2-step and/or 4-step RA resources for MO-SDT. When both 2-step and 4-step RA resources for MO-SDT are configured, the UE selects the RA type according to clause 9.2.6. If MT-SDT procedure is initiated over RACH, only the RACH resources not configured for SDT can be used by the UE. Contention-free random access (CFRA) is not supported by SDT over RACH.

Once initiated, the SDT procedure is successfully completed after the UE is directed to RRC_IDLE (via RRCRelease) or to continue in RRC_INACTIVE (via RRCRelease or RRCReject) or to RRC_CONNECTED (via RRCResume or RRCSetup). Alternatively, once initiated, the SDT procedure is unsuccessfully completed upon cell re-selection, expiry of the SDT failure detection timer, a MAC entity reaching a configured maximum physical random access channel (PRACH) preamble transmission threshold, a radio link control (RLC) entity reaching a configured maximum retransmission threshold, or integrity check failure while SDT procedure is ongoing, or expiry of SDT-specific timing alignment timer or configuredGrantTimer while SDT procedure is ongoing over CG and the UE has not received a response from the network after the initial PUSCH transmission.

Upon successful completion of the SDT procedure via an RRCRelease message including resumeIndication, the UE triggers the initiation of RRC Resume procedure. Upon the unsuccessful completion of the SDT procedure, the UE transitions to RRC_IDLE. For SDT, the network should not send RRCReject in response to RRCResume Request/RRCResumeRequest1 if DL data over any radio bearer configured for SDT is transmitted.

The initial PUSCH transmission during the SDT procedure includes at least the CCCH message. When using CG resources for initial SDT transmission, the UE can perform autonomous retransmission of the initial transmission if the UE does not receive confirmation from the network (dynamic UL grant or DL assignment) before a configured timer expires. After the initial PUSCH transmission, subsequent transmissions are handled differently depending on the type of resource used to initiate the SDT procedure.

When using CG resources, the network can schedule subsequent UL transmissions using dynamic grants or they can take place on the following CG resource occasions. The DL transmissions are scheduled using dynamic assignments. The UE can initiate subsequent UL transmission only after reception of confirmation (dynamic UL grant or DL assignment) for the initial PUSCH transmission from the network. For subsequent UL transmission, the UE cannot initiate re-transmission over a CG resource.

When using RACH resources, the network can schedule subsequent UL and DL transmissions using dynamic UL grants and DL assignments, respectively, after the completion of the RA procedure. When the SDT procedure is initiated, AS security is applied for all the radio bearers enabled for SDT. While the SDT procedure is ongoing, if data appears in a buffer of any radio bearer not enabled for SDT, the UE initiates a transmission of a non-SDT data arrival indication using UEAssistanceInformation message to the network and, if available, includes the resume cause.

While the SDT procedure is ongoing and RA procedure is triggered (e.g., upon UL data arrival), only the RACH resources not configured for SDT can be used by the UE.

SDT procedure over CG resources can only be initiated with valid UL timing alignment. The UL timing alignment is maintained by the UE based on a SDT-specific timing alignment timer configured by the network via dedicated signalling and, for initial CG-SDT transmission, also by DL RSRP of configured number of highest ranked SSBs which are above a configured RSRP threshold. Upon expiry of the SDT-specific timing alignment timer, the CG resources are released while maintaining the CG resource configuration.

Logical channel restrictions configured by the network while in RRC_CONNECTED state and/or in RRCRelease message for radio bearers enabled for SDT, if any, are applied by the UE during SDT procedure.

The network may configure UE to apply robust header compression (ROHC) continuity for SDT either when the UE initiates SDT in the PCell of the UE when the RRCRelease with suspend indication was received or when the UE initiates SDT in a cell of its RAN-based notification area (RNA).

For the SDT procedure over CG resources, the network may configure maximum time duration until the next valid CG occasion for initial CG-SDT transmission based on which the UE decides whether SDT procedure over CG resources can be initiated. The maximum time duration is configured per logical channel for MO-SDT and per UE for MT-SDT.

As briefly mentioned above, LP-WUR is being studied for NR. The study considers the usage of a separate LP-WUR at the UE, and evaluates how that can reduce the UE power consumption. FIG. 2 illustrates example UE operations with LP-WUR. The intention is that the main radio 220 of the UE 201 can be in a sleep mode or even powered off for power saving and be activated only upon the reception of the wake-up signal from the network. Basically, the network triggers the UE 201 to wake-up exactly when needed in an event-driven manner, by transmitting a special WUS to the UE 201. The special WUS is monitored by the dedicated low-power WUS receiver 210 at the UE. When the UE 201 receives the WUS, the WUS receiver 210 can trigger the wake-up of the ordinary NR transceiver and communication can start. Thus, the ultra-low power receiver 210 wakes up the main radio 220 and otherwise, the main radio 220 is OFF or kept in a deep sleep mode, as shown in FIG. 2. The assumption is that the low-power wake-up receiver can be operated in an always ‘on’ manner with very low power consumption. In fact, it is expected that it will consume significantly less power compared to the NR transceiver, by designing a simple (WUS) signal and the use of dedicated hardware for its monitoring, which is only able to receive the WUS.

Furthermore, it has been considered that serving cell evaluations could be offloaded from MR to low power receiver to enable large power saving. The low power receiver could carry the serving cell evaluation related measurements based on new reference signals, LP-SSs, or SSB depending on the type of the low power receiver. Only serving cell evaluations are considered to be offloaded to the low power receiver as the coverage of the low power signals and receiver is limited (the low power receiver includes only 1 RX and has higher noise figure).

Different types of the low power receiver have been considered, mainly envelope detectors (EDs) and sequence detectors. If the low power receiver employs EDs, it is only capable of detecting ON/OFF keying. The low power receiver has no in—phase and quadrature (IQ) branch to perform coherent/sequence detection. This receiver can only receive LP-WUS and LP-SS. If the low power receiver is an OFDM low power receiver, it uses IQ branches to perform coherent detection. It consumes more power due to the better accuracy of crystal oscillators (XO) used to drive the phase—locked loops (PLLs). This type of receiver can receive also SSS/PSS in addition to LP-WUS.

The following agreements have been made in RAN4 regarding the scenarios supported, where cases #1 to #5 are to be considered for RRM relaxation. Table 1 shows details of cases #1 to #4.

TABLE 1

| RRM | MR serving | MR neighboring | |
|---|---|---|---|
| measurement | cell | cell | LR |
| case index | measurement | measurement | measurement |
| #1 Fully | Off | Off: FFS the | ON |
| offloading case | | condition and | |
| | | the details | |
| #2 Relaxed | On with | Off | ON |
| case a | relaxation | | |
| | measurement | | |
| #3 Relaxed | On with | On with | ON |
| case b | relaxation | relaxation | |
| | measurement | measurement | |
| #4 Relaxed | Off | On, FFS the | ON |
| case c | | condition and | |
| | | the details | |

Case #3 is to be considered for RRM relaxation and serving cell measurement offloading. For serving cell measurement, Option1, Option 2, Option 3 and other options are further discussed. For Option 1, whether to combine the measurements across the two radios (i.e., MR and WUR) is further discuss. For Option 2, from RAN4 requirement perspective, combining the measurements across the two radios (i.e., MR and WUR) is not considered. For Option 3, it is up to UE implementation whether to combine the measurement across the two radios. Table 2 shows details of cases #3.

TABLE 2

| RRM | MR serving | MR neighboring | |
|---|---|---|---|
| measurement | cell | cell | LR |
| case index | measurement | measurement | measurement |
| #3 Relaxed | On with | On with | ON |
| case b | relaxation | relaxation | |
| | measurement | measurement | |

Note that, in RAN4 understanding, the discussion of the related measurement criteria (i.e., whether to use the legacy or new criteria) is out of RAN4 responsibility.

In view of the above, MO-SDT/MT-SDT can be initiated by the UE only if the DL RSRP is above a configured threshold. The SDT procedure over CG resources can only be initiated with valid UL timing alignment. The UL timing alignment is maintained by the UE based on a SDT-specific timing alignment timer configured by the network via dedicated signalling and, for initial CG-SDT transmission, also by DL RSRP of configured number of highest ranked SSBs which are above a configured RSRP threshold. Upon expiry of the SDT-specific timing alignment timer, the CG resources are released while maintaining the CG resource configuration.

When the UE is monitoring LP-WUS its MR is sleeping and is not performing any activities such as PDCCH monitoring or measurements. The problem is that above RSRP measurements cannot be done for MO-SDT or MT-SDT or for the SDT procedure over CG resources if the MR is sleeping (or the measurements are offloaded to the low power receiver).

In accordance with some example embodiments of the present disclosure, there is provided a solution for SDT transmission with LP-WUS. In the solution, a first apparatus performs one or more measurements on a reference signal from a second apparatus. For example, the one or more measurements are performed during monitoring a LP-WUS by a low power receiver. The reference signal is based on a synchronization signal. The first apparatus evaluates a reference signal quality of the reference signal based on the one or more measurements and a first signal quality threshold. Based on that the reference signal quality meets a condition associated with the first signal quality threshold, the first apparatus initiates an SDT to the second apparatus.

In accordance with some example embodiments of the present disclosure, there is further provided a solution for SDT transmission with LP-WUS. In the solution, upon exiting monitoring on a low power wake up signal, a first apparatus performs one or more measurements on a reference signal from a second apparatus. The first apparatus evaluates a reference signal quality of the reference signal based on the one or more measurements and a second signal quality threshold. If the reference signal quality meets a condition associated with the second signal quality threshold, the first apparatus initiates an SDT to the second apparatus.

In this way, a functionality is introduced which makes it possible for the UE to evaluate whether the SDT procedure can be initiated, even in the case where the UE monitors the LP-WUS, and the main receiver is not performing measurements. The advantages are brought that it is possible to initiate the SDT procedure immediately after receiving the LP-WUS or being paged addressing. Furthermore, there is no significant delay due to signal quality measurements for SDT initiation.

Example embodiments of the present disclosure will be described in detail below with reference to the accompanying drawings.

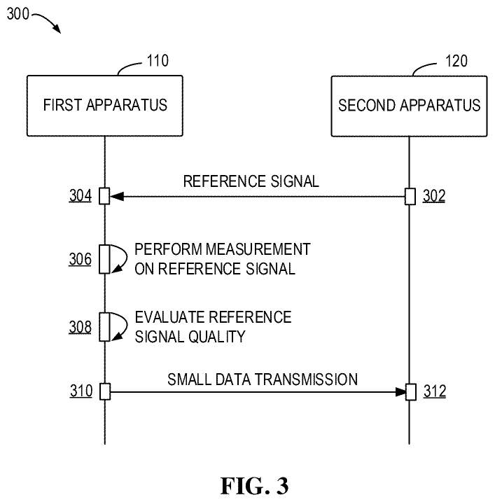

Reference is now made to FIG. 3, which illustrates a signalling chart 300 for SDT transmission according to some example embodiments of the present disclosure. The signalling chart 300 involves the first apparatus 110 and second apparatus 120, which may be described with reference to FIG. 1.

Initial conditions for the following example embodiments may include that the first apparatus 110 monitors the LP-WUS for example by a low power receiver and the main receiver does not perform regular cell (re)selection measurements, i.e., main receiver based RSRP results are not available. There is a need to send or receive data. For example, UL data becomes available for transmission or the first apparatus 110 receives LP-WUS/PEI/paging DCI.

The second apparatus 120 transmits 302 a reference signal to the first apparatus 110. The reference signal may be based on a synchronization signal. For example, the reference signal may be or include LP-SS based reference signal, PSS based reference signal or SSS based reference signal.

As described above, the first apparatus 110 includes the main receiver and the low power receiver. Based on receiving 304 the reference signal, the first apparatus 110 performs 306 one or more measurements on the reference signal. The one or more measurements may be performed during monitoring LP-WUS from the second apparatus 120. For example, the one or more measurements may be performed during the main receiver is in a sleep mode. In some example embodiments, the one or more measurements may be performed by the low power receiver of the first apparatus 110, for example by the LR.

In some example embodiments, if a criterion associated with the main receiver is met, the first apparatus 110 may perform the measurement(s) on the reference signal.

Continuing with reference to FIG. 3, after performing the measurement(s) on the reference signal, the first apparatus 110 evaluates 308 a reference signal quality of the reference signal based on the measurement(s) performed and a first signal quality threshold (also referred to as an SDT threshold).

In some example embodiments, the criterion may include that a measurement by the main receiver is transferred to the low power receiver. For example, the first signal quality threshold evaluations are used if the main receiver serving cell measurements have fully been offloaded to the low power receiver. Alternatively, or additionally, the criterion may include that a relaxation duration of a measurement by the main receiver exceeds a time duration. For example, the signal quality threshold evaluations are used if the relaxation duration is exceeding a pre-predetermined or preconfigured time duration.

As mentioned above, the first apparatus 110 evaluates 308 the reference signal quality of the reference signal. For example, the reference signal quality may include RSRP, and accordingly the first signal quality threshold may include an RSRP threshold. Alternatively, or in addition, the reference signal quality may include a reference signal received quality (RSRQ), and accordingly the first signal quality threshold may include an RSRQ threshold.

Different reference signals, e.g., LP-SS based reference signal or PSS/SSS reference based signal, may correspond to different first signal quality thresholds. The following will describe how to determine the first signal quality threshold.

In some example embodiments, the first apparatus 110 may determine the first signal quality threshold based on a threshold offset and a reference threshold for a reference signal measurement. For example, the measurement(s) performed by the low power receiver may be used with an offset to evaluate an existing SDT threshold. The reference threshold may refer to the existing SDT threshold sdt-RSRP-Threshold, which represents a RSRP threshold for the first apparatus 110 to determine whether to perform the SDT procedure.

Since the first signal quality threshold is determined at least based on the threshold offset, the following will describe how to determine and configure the threshold offset in detail with reference to several example embodiments.

In some example embodiments, the threshold offset may be based on a type of the reference signal. The type of the reference signal may include PSS, SSS or LP-SS.

In some example embodiments, the reference signal may be based on an LP-SS, and the first apparatus 110 may receive configuration information from the second apparatus 120. The configuration information may indicate respective signal quality thresholds for different types of reference signals. If the configuration information indicates the first signal quality threshold for the LP-SS, the first apparatus 110 may evaluate the reference signal quality based on the measurement(s) and the first signal quality threshold indicated for the LP-SS.

Alternatively, or additionally, the threshold offset may be based on a property of a receiver for receiving the reference signal. The receiver for receiving the reference signal may be or include the low power receiver. The property of the low power receiver may refer to a type of the low power receiver (such as ED LR or OFDM LR), an accuracy of the low power receiver, or any other appropriate feature of the low power receiver. In this way, receiver type specific threshold offset or separate threshold offsets are introduced.

For example, it may be required that due to the accuracy of the measurement(s) performed by the low power receiver, upon the first signal quality threshold is evaluated with the measurements, the first apparatus should apply a threshold offset (e.g., 3 dB) to the first signal quality threshold to compensate for the accuracy. The threshold offset may be based on the accuracy of the low power receiver, which may be specified in minimum requirements, or it may be a capability.

For another example, the threshold offset may be added to the current SDT RSRP thresholds, because the measurement accuracy of the low power receiver may be different or worse than the measurement accuracy of the main receiver.

In one example embodiment, the threshold offset may be expressed in +/−dBs. If (the RSRP measured by the low power receiver+the threshold offset) is greater than the signaled threshold(s), the SDT procedure is allowed. If (the RSRP measured by the low power receiver—the threshold offset) is less than the signaled threshold(s), the SDT procedure is allowed.

Alternatively, or additionally, the threshold offset may be based on a type of SDT. For example, the threshold offsets for different types of SDT may be different. Specifically, the threshold offsets may be different per LP-SS or PSS/SSS, or it may be that the first signal quality thresholds may be not evaluated if the LP-SS is used. Optionally, the threshold offsets may have separate configurations and if configured, only then the first apparatus 110 may evaluate the reference signal quality of the reference signal.

In some example embodiments, the SDT may include a mobile originated SDT. Alternatively, or additionally, the SDT may include a mobile terminated SDT. For example, a first threshold offset is configured for a mobile originated SDT, and a second threshold offset is configured for a mobile terminated SDT.

Alternatively, or additionally, the threshold offset may be based on a resource to be used for the SDT. For example, the threshold offset for SDT over a random access (RA) resource or SDT over a CG resource may be different.

In some example embodiments, the SDT may include at least one of: a mobile originated SDT over a RA resource, a mobile originated SDT over a CG resource, a mobile terminated SDT over a RA resource, or a mobile terminated SDT over a CG resource. For example, four different threshold offsets may be configured for the four resources above to be used for the SDT, respectively. In this way, MO-SDT and MT-SDT can be performed either over CG resource or RA resource.

The above has described how to determine the first signal quality threshold and the associated threshold offset. With regard to the configuration of the first signal quality threshold, in some example embodiments, the first signal quality threshold may be configured by the second apparatus 120 separately from a reference threshold for a reference signal measurement.

For example, separate low power receiver based SDT RSRP thresholds are introduced. If the RSRP measured by the low power receiver is greater than the signaled threshold(s), the SDT procedure is allowed. If the RSRP measured by the low power receiver is less than the signaled threshold(s), the SDT procedure is allowed.

In some example embodiments, in the case that the first signal quality threshold is configured by the second apparatus 120 separately, the first signal quality threshold may be based on at least one of: a type of the reference signal, a property of a receiver for receiving the reference signal, a type of the SDT, or a resource to be used for the SDT. The description about the first signal quality threshold may refer to the foregoing example embodiments, which will not be repeated here.

In some example embodiments, the second apparatus 120 may configure separate signal quality thresholds for different types of SDT, for example MO-SDT, MT-SDT, or CG-SDT. In such example embodiments, the first apparatus 110 may receive from the second apparatus 120, configuration information indicating separate signal quality thresholds for different types of SDT, and determine the first signal quality threshold based on the configuration information and a type of the SDT. For example, in case of MO-SDT, the first signal quality threshold to evaluate is determined as the signal quality threshold configured for the MO-SDT.

Continuing with reference to FIG. 3, after performing 306 the measurement(s) on the reference signal, the first apparatus 110 may evaluate 308 the reference signal quality based on the measurement(s) and the first signal quality threshold. In some example embodiments, the measurement(s) may be performed in a non-connected state of the first apparatus 110. If time periods of the measurement(s) are equal to or longer than an evaluation time period, the first apparatus 110 may evaluate 308 the reference signal quality based on the measurement(s) and the first signal quality threshold.

For example, the first signal quality threshold is evaluated if one full evaluation period of the low power receiver is performed when the first apparatus 110 has been in the inactive/idle-mode. Specifically, if the first apparatus 110 is required to perform 4 measurement periods for reliable LP-SS measurement, and two samples are needed for a measurement period. The first apparatus 110 is required to perform 8 samples with the LP-SS periodicity before the first signal quality threshold may be evaluated.

In other words, there may be a time Y from when the first apparatus 110 enters the main receiver relaxation/offloading that is required to be passed before the low power receiver can be used for evaluating SDT threshold. If the first apparatus 110 is required to exist before this, the signal quality threshold evaluation is not performed.

In some example embodiments, the measurement(s) may be performed before the first apparatus 110 enters into a measurement relaxation mode. Upon the first apparatus 110 entering the measurement relaxation mode, it may evaluate the reference signal quality based on the measurement(s) and the first signal quality threshold.

For example, the first apparatus 110 is required to perform full evaluation by the low power receiver prior to entering the main receiver relaxation mode, then it may utilize the low power receiver measurements directly after the main receiver measurements are offloaded to the low power receiver (because the evaluation period was performed prior to offloading entry).

In some example embodiments, the first apparatus 110 may store a result of the evaluation until it exits monitoring an LP-WUS. For example, the result of the evaluation is stored. The storing may be until the first apparatus 110 exits LP-WUS monitoring by receiving LP-WUS signal or by measurement-based exit or paging.

Referring to FIG. 3, based on that the reference signal quality meets a condition associated with the first signal quality threshold, the first apparatus 110 initiates 310 an SDT to the second apparatus 120. The second apparatus 120 receives 312 the small data transmitted by the first apparatus 110. In some example embodiments, the condition may include that the reference signal quality is above the first signal quality threshold.

In some example embodiments, other conditions may need to be fulfilled before the SDT can be initiated. For example, for MO-SDT, based on that all the pending data in the UL is mapped to the radio bearers configured for the SDT, the first apparatus 110 may initiate the SDT to the second apparatus 120. For MT-SDT, based on that paging message includes an MT-SDT indication, the first apparatus 110 may initiate the SDT to the second apparatus 120.

The MT-SDT indication may include at least one of: a data volume threshold (e.g., sdt-DataVolumeThreshold) for the first apparatus 110 to determine whether to perform the SDT procedure initiated for MO-SDT, a time threshold (e.g., cg-MT-SDT-MaxDurationToNextCG-Occasion) which is used by the first apparatus 110 to determine whether to perform CG-SDT for MT-SDT, or a time threshold configured per logical channel (e.g., cg-SDT-MaxDurationToNextCG-Occasion) which is used by the first apparatus 110 to determine whether to perform CG-SDT for MO-SDT. Note that time alignment needs to be valid for CG-SDT.

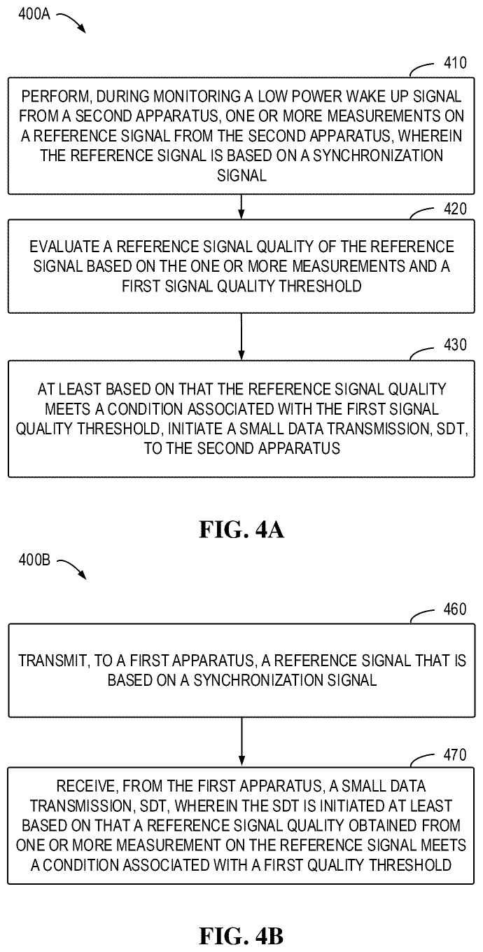

FIG. 4A shows a flowchart of an example method 400 A implemented at a first apparatus in accordance with some example embodiments of the present disclosure

At block 410, the first apparatus 110 performs, during monitoring a low power wake up signal from a second apparatus, one or more measurements on a reference signal from the second apparatus, wherein the reference signal is based on a synchronization signal.

At block 420, the first apparatus 110 evaluates a reference signal quality of the reference signal based on the one or more measurements and a first signal quality threshold.

At block 430, the first apparatus 110 at least based on that the reference signal quality meets a condition associated with the first signal quality threshold, initiates a small data transmission, SDT, to the second apparatus.

In some example embodiments, the method 400A further comprises: determining the first signal quality threshold based on a threshold offset and a reference threshold for a reference signal measurement.

In some example embodiments, the threshold offset is based on at least one of: a type of the reference signal, a property of a receiver for receiving the reference signal, a type of the SDT, or a resource to be used for the SDT.

In some example embodiments, the first signal quality threshold is configured by the second apparatus separately from a reference threshold for a reference signal measurement.

In some example embodiments, the first signal quality threshold is based on at least one of: a type of the reference signal, a property of a receiver for receiving the reference signal, a type of the SDT, or a resource to be used for the SDT.

In some example embodiments, the method 400A further comprises: in accordance with a determination that a criterion associated with a main receiver of the first apparatus is met, performing the one or more measurements on the reference signal.

In some example embodiments, the criterion comprises at least one of: that a measurement by the main receiver is transferred to a low power receiver of the first apparatus, or that a relaxation duration of a measurement by the main receiver exceeds a time duration.

In some example embodiments, the method 400A further comprises: in accordance with a determination that time periods of the one or more measurements are equal to or longer than an evaluation time period, evaluating the reference signal quality based on the one or more measurements and the first signal quality threshold.

In some example embodiments, the method 400A further comprises: upon the first apparatus entering the measurement relaxation mode, evaluating the reference signal quality based on the one or more measurements and the first signal quality threshold.

In some example embodiments, the method 400A further comprises: storing a result of the evaluation until the first apparatus exits monitoring a low power wake up signal.

In some example embodiments, the condition comprises that the reference signal quality is above the first signal quality threshold.

In some example embodiments, the method 400A further comprises: receiving, from the second apparatus, configuration information indicating respective signal quality thresholds for different types of reference signals; and in accordance with a determination that the configuration information indicates the first signal quality threshold for the LP-SS, evaluating the reference signal quality based on the one or more measurements and the first signal quality threshold indicated for the LP-SS.

In some example embodiments, the one or more measurements are performed by a low power receiver of the first apparatus.

In some example embodiments, the SDT comprises at least one of: a mobile originated SDT, or a mobile terminated SDT.

In some example embodiments, the SDT comprises at least one of: a mobile originated SDT over a random access resource, a mobile originated SDT over a configured grant resource, a mobile terminated SDT over a random access resource, or a mobile terminated SDT over a configured grant resource,

In some example embodiments, the method 400A further comprises: receiving, from the second apparatus, configuration information indicating separate signal quality thresholds for different types of SDT; and determining the first signal quality threshold based on the configuration information and a type of the SDT.

FIG. 4B shows a flowchart of an example method 400B implemented at a second apparatus in accordance with some example embodiments of the present disclosure.

At block 460, the second apparatus 120 transmits, to a first apparatus, a reference signal that is based on a synchronization signal.

At block 470, the second apparatus 120 receives, from the first apparatus, a small data transmission, SDT, wherein the SDT is initiated at least based on that a reference signal quality obtained from one or more measurement on the reference signal meets a condition associated with a first quality threshold.

In some example embodiments, the method 400B further comprises: transmitting, to the first apparatus, a threshold offset for determining the first quality threshold based on a reference threshold for a reference signal measurement.

In some example embodiments, the threshold offset is based on at least one of: a type of the reference signal, a property of the low power a receiver for receiving the reference signal, a type of the SDT, or a resource to be used for the SDT.

In some example embodiments, the method 400B further comprises: configuring the first signal quality threshold separately from a reference threshold for a reference signal measurement.

In some example embodiments, the first signal quality threshold is based on at least one of: a type of the reference signal, a property of the low power a receiver for receiving the reference signal, a type of the SDT, or a resource to be used for the SDT.

In some example embodiments, the method 400B further comprises: transmitting, to the first apparatus, configuration information indicating respective quality thresholds for different types of reference signals.

In some example embodiments, the SDT comprises at least one of: a mobile originated SDT, or a mobile terminated SDT.

In some example embodiments, the SDT comprises at least one of: a mobile originated SDT over a random access resource, a mobile originated SDT over a configured grant resource, a mobile terminated SDT over a random access resource, or a mobile terminated SDT over a configured grant resource,

In some example embodiments, the method 400B further comprises: transmitting, to the first apparatus, configuration information indicating separate signal quality thresholds for different types of SDT.

In some example embodiments, a first apparatus capable of performing any of the method 400A may comprise means for performing the respective operations of the method 400A and/or any of the described one or more example embodiments thereof. The means may be implemented in any suitable form. For example, the means may be implemented in a circuitry or software module.

In some example embodiments, a second apparatus capable of performing any of the method 400B may comprise means for performing the respective operations of the method 400B and/or any of the described one or more example embodiments thereof. The means may be implemented in any suitable form. For example, the means may be implemented in a circuitry or software module.

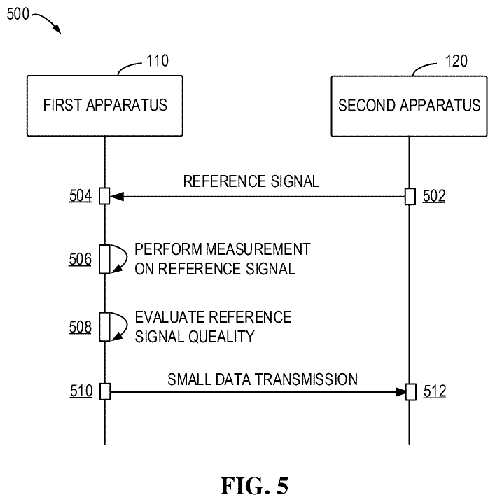

Reference is now made to FIG. 5, which illustrates a signalling chart 500 for SDT transmission according to some example embodiments of the present disclosure. The signalling chart 500 involves the first apparatus 110 and second apparatus 120, and the first apparatus 110 includes the main receiver and the low power receiver. The signalling chart 500 will be described with reference to FIG. 1.

Initial conditions for the following example embodiments may include that the first apparatus 110 monitors LP-WUS and the main receiver does not perform regular cell (re)selection measurements, i.e., main receiver based RSRP results are not available. There is a need to send or receive data. For example, UL data becomes available for transmission or the first apparatus 110 receives LP-WUS/PEI/paging DCI.

The second apparatus 120 transmits 502 a reference signal to the first apparatus 110. The first apparatus 110 receives 504 the reference signal. The first apparatus 110 may exit the LP-WUS mode. For example, the exiting may include an LP-SS measurement based exit performed by the low power receiver, a PSS/SSS measurement based exit performed by the low power receiver, an exit trigged by the LP-WUS, or an exit triggered by paging (e.g. if the first apparatus 110 does not monitor the LP-WUS).

Upon exiting monitoring on an LP-WUS, the first apparatus 110 performs 506 one or more measurements on the reference signal received. For example, the main receiver of the first apparatus 110 performs the measurement(s).

In some example embodiments, a time period of the one or more measurements may be equal to or shorter than an evaluation period. For example, the required measurement time length may be reduced for the main receiver measurements.

In some example embodiments, the one or more measurements may be performed at the first measurement occasion after existing the monitoring. For example, the main receiver may perform the measurement(s) at the first measurement occasion after the LP-WUS wake-up signal. For another example, the main receiver may perform the measurement(s) at the next SSB occasion or in the next DRX cycle. Both cases would be considered as performing the measurement(s) “immediately”.

Alternatively, or additionally, the one or more measurements may be performed without following a configured measurement periodicity.

In some example embodiments, the configured measurement periodicity may be based on a configured discontinuous reception cycle. For example, the configured measurement periodicity depends on the configured DRX cycle.

In some example embodiments, if a criterion associated with a low power receiver of the first apparatus 110 is met, the first apparatus 110 may perform the measurement(s) upon exiting monitoring. For example, the first apparatus 110 or the main receiver of the first apparatus 110 performs (immediately after the main receiver has woken up) one or more RSRP measurements for evaluation whether the SDT procedure can be initiated. In some related examples, the first apparatus 110 may determine, based on low power receiver based measurements (on the LP-SS), whether there is a need to perform the main receiver measurements.

Continuing with reference to FIG. 5, the first apparatus 110 evaluates 508 a reference signal quality of the reference signal based on the measurement(s) performed and a second signal quality threshold.

In some example embodiments, the main receiver may perform one evaluation period (e.g. 2 samples) for the SDT evaluation.

In some example embodiments, the low power receiver measurements may be used for evaluation whether the SDT procedure can be initiated. These measurements can be performed if the first apparatus 110 monitors the LP-WUS. These low power receiver measurements may be already available since the low power receiver measures serving cell quality if the LP-WUS is monitored.

In some example embodiments, if a reference signal measurement performed by the low power receiver does not meet a measurement requirement, the first apparatus 110 may perform the measurement(s) upon exiting the monitoring. For example, the measurement requirement may include that the measurement accuracy or the number of measurements is not sufficient.

In some example embodiments, the measurement requirement may include a signal quality measured by the low power receiver is below a threshold. For example, the measured RSRP by the LR is below an RSRP threshold.

Alternatively, or additionally, the measurement requirement may include an accuracy of the reference signal measurement by the low power receiver is below an accuracy threshold.

Alternatively, or additionally, the measurement requirement may include a time period of the reference signal measurement performed by the low power receiver is equal to or shorter than an evaluation time period. For example, measurements performed by the LR corresponds to a time period less than a full evaluation period.

In some example embodiments, if a type of the low power receiver is a predetermined receiver type (e.g., the low power receiver is a type with low capability), the first apparatus 110 may perform the measurement(s) upon exiting the monitoring. Alternatively, or additionally, if a further reference signal measured by the low power receiver is based on low power synchronization signal, the first apparatus 110 may perform the measurement(s) upon exiting the monitoring.

In some example embodiments, a type of the low power receiver may include at least one of: ED low power receiver, or OFDM low power receiver.

In some example embodiments, the first apparatus 110 may determine the second signal quality threshold based on a threshold offset and a reference threshold for a reference signal measurement. For example, the measurement(s) performed by the low power receiver may be used with an offset to evaluate an existing SDT threshold. The reference threshold may refer to the existing SDT threshold sdt-RSRP-Threshold, which represents a RSRP threshold for the first apparatus 110 to determine whether to perform the SDT procedure.

Since the second signal quality threshold is determined at least based on the threshold offset, the following will describe how to determine and configure the threshold offset in detail with reference to several example embodiments.

In some example embodiments, the threshold offset may be based on a type of SDT. For example, the threshold offsets for different types of SDT may be different. Specifically, the threshold offsets may be different per LP-SS or PSS/SSS, or it may be that the second signal quality thresholds may be not evaluated if the LP-SS is used. Optionally, the threshold offsets may have separate configurations and if configured, only then the first apparatus 110 may evaluate the reference signal quality of the reference signal.

In some example embodiments, the SDT may include a mobile originated SDT. Alternatively, or additionally, the SDT may include a mobile terminated SDT. For example, a first threshold offset is configured for a mobile originated SDT, and a second threshold offset is configured for a mobile terminated SDT.

Alternatively, or additionally, the threshold offset may be based on a resource to be used for the SDT. For example, the threshold offset for SDT over a random access (RA) resource or SDT over a CG resource may be different.

In some example embodiments, the SDT may include at least one of: a mobile originated SDT over a RA resource, a mobile originated SDT over a CG resource, a mobile terminated SDT over a RA resource, or a mobile terminated SDT over a CG resource. For example, four different threshold offsets may be configured for the four resources above to be used for the SDT, respectively. In this way, MO-SDT and MT-SDT can be performed either over CG resource or RA resource.

The above has described how to determine the second signal quality threshold and the associated threshold offset. With regard to the configuration of the second signal quality threshold, in some example embodiments, the second signal quality threshold may be configured by the second apparatus 120 separately from a reference threshold for a reference signal measurement.

For example, separate low power receiver based SDT RSRP thresholds are introduced. If the RSRP measured by the low power receiver is greater than the signaled threshold(s), the SDT procedure is allowed. If the RSRP measured by the low power receiver is less than the signaled threshold(s), the SDT procedure is allowed.

In some example embodiments, in the case that the second signal quality threshold is configured by the second apparatus 120 separately, the second signal quality threshold may be based on at least one of: a type of the SDT, or a resource to be used for the SDT. The description about the second signal quality threshold may refer to the foregoing example embodiments, which will not be repeated here.

In some example embodiments, the second apparatus 120 may configure separate signal quality thresholds for different types of SDT, for example MO-SDT, MT-SDT, or CG-SDT. In such example embodiments, the first apparatus 110 may receive from the second apparatus 120, configuration information indicating separate signal quality thresholds for different types of SDT, and determine the first signal quality threshold based on the configuration information and a type of the SDT. For example, in case of MO-SDT, the first signal quality threshold to evaluate is determined as the signal quality threshold configured for the MO-SDT.

Referring to FIG. 5, based on that the reference signal quality meets a condition associated with the second signal quality threshold, the first apparatus 110 initiates 510 an SDT to the second apparatus 120. The second apparatus 120 receives 512 the small data transmitted by the first apparatus 110. In some example embodiments, the condition may include that the reference signal quality is above the second signal quality threshold.

In some example embodiments, other conditions may need to be fulfilled before the SDT can be initiated. For example, for MO-SDT, based on that all the pending data in the UL is mapped to the radio bearers configured for the SDT, the first apparatus 110 may initiate the SDT to the second apparatus 120. For MT-SDT, based on that paging message includes an MT-SDT indication, the first apparatus 110 may initiate the SDT to the second apparatus 120.

The MT-SDT indication may include at least one of: a data volume threshold (e.g., sdt-DataVolumeThreshold) for the first apparatus 110 to determine whether to perform the SDT procedure initiated for MO-SDT, a time threshold (e.g., cg-MT-SDT-MaxDurationToNextCG-Occasion) which is used by the first apparatus 110 to determine whether to perform CG-SDT for MT-SDT, or a time threshold configured per logical channel (e.g., cg-SDT-MaxDurationToNextCG-Occasion) which is used by the first apparatus 110 to determine whether to perform CG-SDT for MO-SDT. Note that time alignment needs to be valid for CG-SDT.

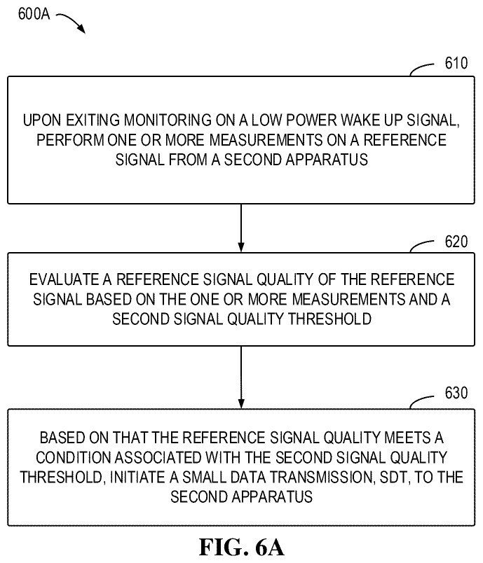

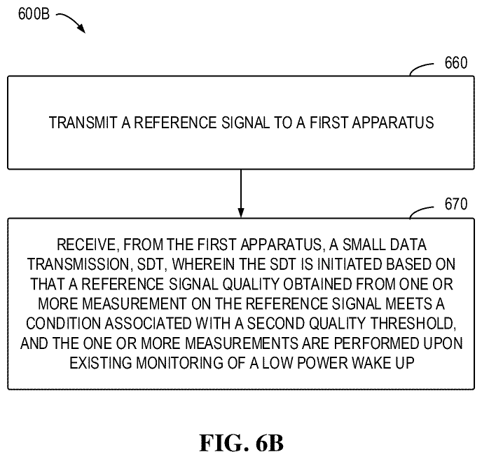

FIG. 6A shows a flowchart of an example method 600A implemented at a first apparatus in accordance with some example embodiments of the present disclosure.

At block 610, upon exiting monitoring on a low power wake up signal, the first apparatus performs one or more measurements on a reference signal from a second apparatus.

At block 620, the first apparatus 110 evaluates a reference signal quality of the reference signal based on the one or more measurements and a second signal quality threshold.

At block 630, based on that the reference signal quality meets a condition associated with the second signal quality threshold, the first apparatus 110 initiates a small data transmission, SDT, to the second apparatus.

In some example embodiments, the method 600A further comprises: in accordance with a determination that a criterion associated with a low power receiver of the first apparatus is met, performing the one or more measurements upon exiting monitoring.

In some example embodiments, the method 600A further comprises: in accordance with a determination that a reference signal measurement performed by the low power receiver does not meet a measurement requirement, performing the one or more measurements upon exiting the monitoring.

In some example embodiments, the measurement requirement comprises at least one of: a signal quality measured by the low power receiver is below a threshold, an accuracy of the reference signal measurement by the low power receiver is below an accuracy threshold, or a time period of the reference signal measurement performed by the low power receiver is equal to or shorter than an evaluation time period.

In some example embodiments, the method 600A further comprises: in accordance with a determination that a type of the low power receiver is a predetermined receiver type or a further reference signal measured by the low power receiver is based on low power synchronization signal, performing the one or more measurements upon exiting the monitoring.

In some example embodiments, the method 600A further comprises: determining the second signal quality threshold based on a threshold offset and a reference threshold for a reference signal measurement.

In some example embodiments, the threshold offset is based on at least one of: a type of the SDT, or a resource to be used for the SDT.

In some example embodiments, the second signal quality threshold is configured by the second apparatus separately from a reference threshold for a reference signal measurement.

In some example embodiments, the second signal quality threshold is based on at least one of: a type of the SDT, or a resource to be used for the SDT.

In some example embodiments, a time period of the one or more measurements is equal to or shorter than an evaluation period.

In some example embodiments, the one or more measurements are performed at the first measurement occasion after existing the monitoring, or the one or more measurements are performed without following a configured measurement periodicity.

In some example embodiments, the configured measurement periodicity is based on a configured discontinuous reception cycle.

In some example embodiments, the condition comprises that the reference signal quality is above the second signal quality threshold.

In some example embodiments, a type of the low power receiver comprises at least one of: envelope detector lower power receiver, or orthogonal frequency division multiplexing lower power receiver.

In some example embodiments, the SDT comprises at least one of: a mobile originated SDT, or a mobile terminated SDT.

In some example embodiments, the SDT comprises at least one of: a mobile originated SDT over a random access resource, a mobile originated SDT over a configured grant resource, a mobile terminated SDT over a random access resource, or a mobile terminated SDT over a configured grant resource,

In some example embodiments, the method 600A further comprises: receiving, from the second apparatus, configuration information indicating separate signal quality thresholds for different types of SDT; and determining the second signal quality threshold based on the configuration information and a type of the SDT.

FIG. 6B shows a flowchart of an example method 600B implemented at a second apparatus in accordance with some example embodiments of the present disclosure.

At block 660, the second apparatus 120 transmits a reference signal to a first apparatus.

At block 670, the second apparatus 120 receives, from the first apparatus, a small data transmission, SDT, wherein the SDT is initiated based on that a reference signal quality obtained from one or more measurement on the reference signal meets a condition associated with a second quality threshold, and the one or more measurements are performed upon existing monitoring of a low power wake up.

In some example embodiments, the method 600B further comprises: transmitting, to the first apparatus, a threshold offset for determining the second quality threshold based on a reference threshold for a reference signal measurement.

In some example embodiments, the threshold offset is based on at least one of: a type of the SDT, or a resource to be used for the SDT.

In some example embodiments, the method 600B further comprises: configuring the second signal quality threshold separately from a reference threshold for a reference signal measurement.

In some example embodiments, the second signal quality threshold is based on at least one of: a type of the SDT, or a resource to be used for the SDT.

In some example embodiments, the method 600B further comprises: transmitting, to the first apparatus, configuration information indicating separate signal quality thresholds for different types of SDT.

In some example embodiments, a first apparatus capable of performing any of the method 600A may comprise means for performing the respective operations of the method 600A and/or any of the described one or more example embodiments thereof. The means may be implemented in any suitable form. For example, the means may be implemented in a circuitry or software module.

In some example embodiments, a second apparatus capable of performing any of the method 600B (for example, the terminal device 110 in FIG. 1 may comprise means for performing the respective operations of the method 600B and/or any of the described one or more example embodiments thereof. The means may be implemented in any suitable form. For example, the means may be implemented in a circuitry or software module.

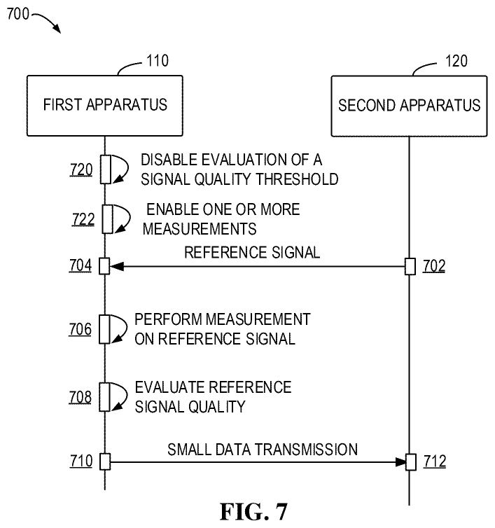

Reference is now made to FIG. 7, which illustrates a signalling chart 700 for SDT transmission according to some example embodiments of the present disclosure. The signalling chart 700 involves the first apparatus 110 and second apparatus 120, which may be described with reference to FIG. 1.

Initial conditions for the following example embodiments may include that the first apparatus 110 monitors the LP-WUS for example by a low power receiver and the main receiver does not perform regular cell (re)selection measurements, i.e., main receiver based RSRP results are not available. There is a need to send or receive data. For example, UL data becomes available for transmission or the first apparatus 110 receives LP-WUS/PEI/paging DCI.

As shown, the first apparatus 110 disables (720), during monitoring the LP-WUS from the second apparatus 120, evaluation of a signal quality threshold for a SDT to the second apparatus 120. For example, the first apparatus 110 disables the SDT feature, in other words the first apparatus 110 does not perform SDT threshold evaluation.

If the first apparatus 110 exit the monitoring of the LP-WUS, the first apparatus 110 enable (722) one or more measurements on a reference signal from the second apparatus 120. For example, the first apparatus 110 initiates SDT measurements once MR of the first apparatus 110 has been woken up. For example, if the LR of the first apparatus 110 is a separate module, the first apparatus 110 is not able to perform SDT threshold evaluation before the MR is up, and from that time at least 2 samples have been received by the MR.

In some example embodiments, upon exiting the monitoring of the low power wake up signal, the main receiver of the first apparatus 110 may perform (704) the one or more measurements. For example, the second apparatus 120 may transmit 702 a reference signal to the first apparatus 110. The first apparatus 110 may receive 704 the reference signal. The first apparatus 110 may exit the LP-WUS mode. For example, the exiting may include an LP-SS measurement based exit performed by the low power receiver, a PSS/SSS measurement based exit performed by the low power receiver, an exit trigged by the LP-WUS, or an exit triggered by paging (e.g. if the first apparatus 110 does not monitor the LP-WUS). Upon exiting monitoring on an LP-WUS, the first apparatus 110 performs 506 one or more measurements on the reference signal received. For example, the main receiver of the first apparatus 110 performs the measurement(s).

In some example embodiments, if a criterion associated with a low power receiver of the first apparatus 110 is met, the first apparatus 110 may perform the measurement(s) upon exiting monitoring. For example, the first apparatus 110 or the main receiver of the first apparatus 110 performs (immediately after the main receiver has woken up) one or more RSRP measurements for evaluation whether the SDT procedure can be initiated. In some related examples, the first apparatus 110 may determine, based on low power receiver based measurements (on the LP-SS), whether there is a need to perform the main receiver measurements.

In some example embodiments, the one or more measurements may be performed at the first measurement occasion after existing the monitoring. For example, the main receiver may perform the measurement(s) at the first measurement occasion after the LP-WUS wake-up signal. For another example, the main receiver may perform the measurement(s) at the next SSB occasion or in the next DRX cycle. Both cases would be considered as performing the measurement(s) “immediately”.

In some example embodiments, if a reference signal measurement performed by the low power receiver does not meet a measurement requirement, the first apparatus 110 may perform the measurement(s) by the main receiver. For example, the measurement requirement may include that the measurement accuracy or the number of measurements is not sufficient.

In some example embodiments, the measurement requirement may include a signal quality measured by the low power receiver is below a threshold. For example, the measured RSRP by the LR is below an RSRP threshold. Alternatively, or additionally, the measurement requirement may include an accuracy of the reference signal measurement by the low power receiver is below an accuracy threshold. Alternatively, or additionally, the measurement requirement may include a time period of the reference signal measurement performed by the low power receiver is equal to or shorter than an evaluation time period. For example, measurements performed by the LR corresponds to a time period less than a full evaluation period.

In some example embodiments, if a type of the low power receiver is a predetermined receiver type (e.g., the low power receiver is a type with low capability), the first apparatus 110 may perform the measurement(s) by the main receiver upon exiting the monitoring or upon waking up. Alternatively, or additionally, if a further reference signal measured by the low power receiver is based on a LP-SS, the first apparatus 110 may perform the measurement(s) by the main receiver upon exiting the monitoring or upon waking up.

In some example embodiments, the first apparatus 110 may perform 706 one or more measurements on the reference signal by the low power receive. The one or more measurements may be performed during monitoring the LP-WUS from the second apparatus 120. For example, the one or more measurements may be performed during the main receiver is in a sleep mode. In some example embodiments, The reference signal may be based on a synchronization signal. For example, the reference signal may be or include LP-SS based reference signal, PSS based reference signal or SSS based reference signal.

Continuing with reference to FIG. 7, after performing the measurement(s) on the reference signal, the first apparatus 110 evaluates 708 a reference signal quality of the reference signal based on the measurement(s) performed and a signal quality threshold (also referred to as an SDT threshold). If the measurements are performed by the main receiver, the signal quality threshold here may be the second signal quality threshold as described above. If the measurements are performed by the low power receiver, the signal quality threshold here may be the first signal quality threshold as described above.

In some example embodiments where the low power received is used to perform the one or more measurements, if at least one evaluation period has passed since the first apparatus enters a non-connected state, the first apparatus 110 may evaluate (708) the reference signal quality based on the one or more measurements and the signal quality threshold. For example, the first apparatus 110 may only use SDT if at least one evaluation period has been passed.

In some example embodiments where the low power received is used to perform the one or more measurements, the measurement(s) may be performed in a non-connected state of the first apparatus 110. If time periods of the measurement(s) are equal to or longer than an evaluation time period, the first apparatus 110 may evaluate 308 the reference signal quality based on the measurement(s) and the first signal quality threshold.

For example, the first signal quality threshold is evaluated if one full evaluation period of the low power receiver is performed when the first apparatus 110 has been in the inactive/idle-mode. Specifically, if the first apparatus 110 is required to perform 4 measurement periods for reliable LP-SS measurement, and two samples are needed for a measurement period. The first apparatus 110 is required to perform 8 samples with the LP-SS periodicity before the first signal quality threshold may be evaluated.

In some example embodiments, the first apparatus 110 may determine the signal quality threshold based on a threshold offset and a reference threshold for a reference signal measurement. For example, the measurement(s) performed by the low power receiver may be used with an offset to evaluate an existing SDT threshold. The reference threshold may refer to the existing SDT threshold sdt-RSRP-Threshold, which represents a RSRP threshold for the first apparatus 110 to determine whether to perform the SDT procedure.

For example, it may be required that due to the accuracy of the measurement(s) performed by the low power receiver, upon the signal quality threshold is evaluated with the measurements, the first apparatus 110 may apply a threshold offset (e.g., 3 dB) to the first signal quality threshold to compensate for the accuracy. The threshold offset may be based on the accuracy of the low power receiver, which may be specified in minimum requirements, or it may be a capability.

For another example, the threshold offset may be added to the current SDT RSRP thresholds, because the measurement accuracy of the low power receiver may be different or worse than the measurement accuracy of the main receiver.

In one example embodiment, the threshold offset may be expressed in +/−dBs. If (the RSRP measured by the low power receiver+the threshold offset) is greater than the signaled threshold(s), the SDT procedure is allowed. If (the RSRP measured by the low power receiver—the threshold offset) is less than the signaled threshold(s), the SDT procedure is allowed.

In some example embodiments, the first apparatus 110 may determine a threshold offset autonomously. The first apparatus 110 may determine the signal quality threshold by applying the determined threshold offset to a reference threshold for a reference signal measurement. The above may be implemented even if there is no offset specified in the UE requirements. In other words, the SDT threshold evaluation may be always an offset from the threshold configured by the gNB.

In some example embodiments, the second apparatus 120 may configure separate signal quality thresholds for different types of SDT, for example MO-SDT, MT-SDT, or CG-SDT. In such example embodiments, the first apparatus 110 may receive from the second apparatus 120, configuration information indicating separate signal quality thresholds for different types of SDT, and determine the signal quality threshold based on the configuration information and a type of the SDT. For example, in case of MO-SDT, the signal quality threshold to evaluate is determined as the signal quality threshold configured for the MO-SDT.

Referring to FIG. 7, based on that the reference signal quality meets a condition associated with the signal quality threshold, the first apparatus 110 initiates 710 an SDT to the second apparatus 120. The second apparatus 120 receives 712 the small data transmitted by the first apparatus 110. In some example embodiments, the condition may include that the reference signal quality is above the first signal quality threshold.

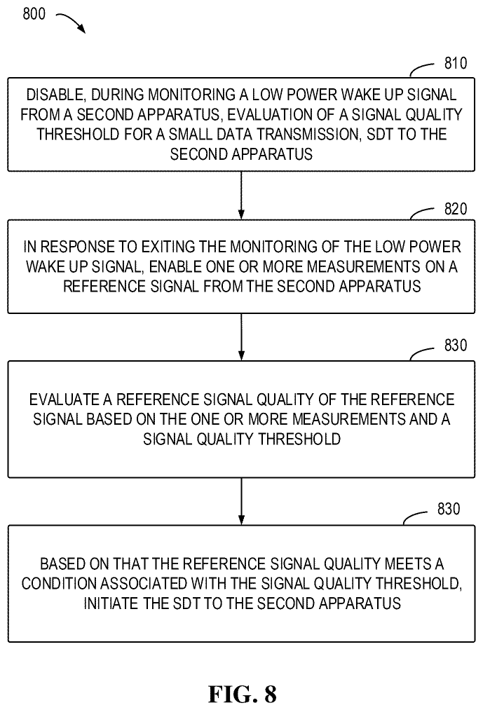

FIG. 8 shows a flowchart of an example method 800 implemented at a first apparatus in accordance with some example embodiments of the present disclosure.

At block 810, the first apparatus 110 disables, during monitoring a low power wake up signal from a second apparatus, evaluation of a signal quality threshold for a small data transmission, SDT to the second apparatus.

At block 820, in response to exiting the monitoring of the low power wake up signal, the first apparatus 110 enables one or more measurements on a reference signal from the second apparatus.

At block 830, the first apparatus 110 evaluates a reference signal quality of the reference signal based on the one or more measurements and a signal quality threshold.

At block 840, based on that the reference signal quality meets a condition associated with the signal quality threshold, the first apparatus 110 initiates the SDT to the second apparatus

In some example embodiments, the method 800 further comprises: upon exiting the monitoring of the low power wake up signal, performing the one or more measurements by a main receiver of the first apparatus.

In some example embodiments, the method 800 further comprises: in accordance with a determination that a criterion associated with a low power receiver of the first apparatus is met, performing the one or more measurements by the main receiver.

In some example embodiments, the method 800 further comprises: in accordance with a determination that a reference signal measurement performed by the low power receiver does not meet a measurement requirement, performing the one or more measurements by the main receiver.

In some example embodiments, the measurement requirement comprises at least one of: a signal quality measured by the low power receiver is below a threshold, an accuracy of the reference signal measurement by the low power receiver is below an accuracy threshold, or a time period of the reference signal measurement performed by the low power receiver is equal to or longer than an evaluation time period.

In some example embodiments, the method 800 further comprises: in accordance with a determination that a type of the low power receiver is a predetermined receiver type or a further reference signal measured by the low power receiver is based on a low power synchronization signal, performing the one or more measurements by the main receiver.

In some example embodiments, the method 800 further comprises: performing the one or more measurement by a low power receiver of the first apparatus, wherein the reference signal is based on a synchronization signal.

In some example embodiments, the method 800 further comprises: in accordance with a determination that at least one evaluation period has passed since the first apparatus enters a non-connected state, evaluating the reference signal quality based on the one or more measurements and the signal quality threshold.

In some example embodiments, the method 800 further comprises: in accordance with a determination that time periods of the one or more measurements time periods are equal to or longer than an evaluation time period, evaluating the reference signal quality based on the one or more measurements and the signal quality threshold.

In some example embodiments, the method 800 further comprises: determining a threshold offset autonomously; and determining the signal quality threshold by applying the determined threshold offset to a reference threshold for a reference signal measurement.

In some example embodiments, the method 800 further comprises: determining the signal quality threshold based on a threshold offset and a reference threshold for a reference signal measurement.

In some example embodiments, the method 800 further comprises: receiving, from the second apparatus, configuration information indicating separate signal quality thresholds for different types of SDT; and determining the signal quality threshold based on the configuration information and a type of the SDT.

In some example embodiments, a first apparatus capable of performing any of the method 800 may comprise means for performing the respective operations of the method 800 and/or any of the described one or more example embodiments thereof. The means may be implemented in any suitable form. For example, the means may be implemented in a circuitry or software module.

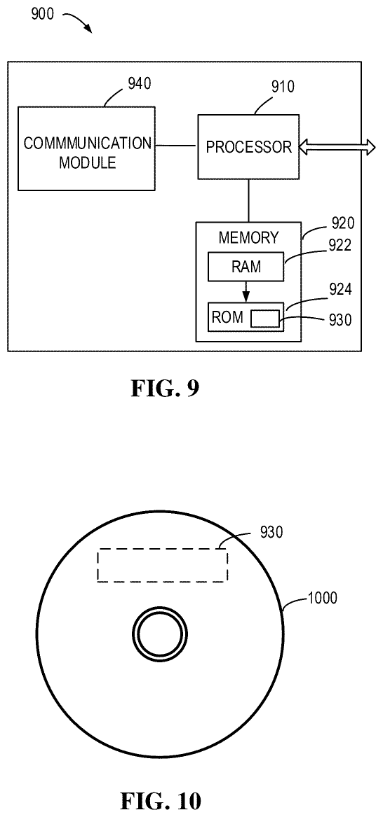

FIG. 9 is a simplified block diagram of a device 900 that is suitable for implementing example embodiments of the present disclosure. The device 900 may be provided to implement a communication device, for example, the first apparatus 110 or the second apparatus 120 as shown in FIG. 1. As shown, the device 900 includes one or more processors 910, one or more memories 920 coupled to the processor 910, and one or more communication modules 940 coupled to the processor 910.

The communication module 940 is for bidirectional communications. The communication module 940 has one or more communication interfaces to facilitate communication with one or more other modules or devices. The communication interfaces may represent any interface that is necessary for communication with other network elements. In some example embodiments, the communication module 940 may include at least one antenna.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random-access memory (RAM) 922 and other volatile memories that will not last in the power-down duration.

A computer program 930 includes computer executable instructions that are executed by the associated processor 910. The instructions of the program 930 may include instructions for performing operations/acts of some example embodiments of the present disclosure. The program 930 may be stored in the memory, e.g., the ROM 924. The processor 910 may perform any suitable actions and processing by loading the program 930 into the RAM 922.

The example embodiments of the present disclosure may be implemented by means of the program 930 so that the device 900 may perform any process of the disclosure as discussed above. The example embodiments of the present disclosure may also be implemented by hardware or by a combination of software and hardware.

In some example embodiments, the program 930 may be tangibly contained in a computer readable medium which may be included in the device 900 (such as in the memory 920) or other storage devices that are accessible by the device 900. The device 900 may load the program 930 from the computer readable medium to the RAM 922 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 10 shows an example of the computer readable medium 1000 which may be in form of CD, DVD or other optical storage disk. The computer readable medium 1000 has the program 930 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general-purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A first apparatus comprising:
at least one processor; and
at least one memory storing instructions that, when executed by the at least one processor, cause the first apparatus at least to:
disable, during monitoring a low power wake up signal from a second apparatus, evaluation of a signal quality threshold for a small data transmission, SDT to the second apparatus;
in response to exiting the monitoring of the low power wake up signal, enable one or more measurements on a reference signal from the second apparatus;
evaluate a reference signal quality of the reference signal based on the one or more measurements and a signal quality threshold; and
based on that the reference signal quality meets a condition associated with the signal quality threshold, initiate the SDT to the second apparatus

2. The first apparatus of claim 1, wherein the first apparatus is caused to:
upon exiting the monitoring of the low power wake up signal, perform the one or more measurements by a main receiver of the first apparatus.

3. The first apparatus of claim 2, wherein the first apparatus is caused to:
in accordance with a determination that a criterion associated with a low power receiver of the first apparatus is met, perform the one or more measurements by the main receiver.

4. The first apparatus of claim 3, wherein the first apparatus is caused to:
in accordance with a determination that a reference signal measurement performed by the low power receiver does not meet a measurement requirement, perform the one or more measurements by the main receiver.

5. The first apparatus of claim 4, wherein the measurement requirement comprises at least one of:
a signal quality measured by the low power receiver is below a threshold,
an accuracy of the reference signal measurement by the low power receiver is below an accuracy threshold, or
a time period of the reference signal measurement performed by the low power receiver is equal to or longer than an evaluation time period.

6. The first apparatus of claim 3, wherein the first apparatus is caused to:
in accordance with a determination that a type of the low power receiver is a predetermined receiver type or a further reference signal measured by the low power receiver is based on a low power synchronization signal, perform the one or more measurements by the main receiver.

7. The first apparatus of claim 1, wherein the first apparatus is caused to:
perform the one or more measurement by a low power receiver of the first apparatus, wherein the reference signal is based on a synchronization signal.

8. The first apparatus of claim 7, wherein the first apparatus is caused to:
in accordance with a determination that at least one evaluation period has passed since the first apparatus enters a non-connected state, evaluate the reference signal quality based on the one or more measurements and the signal quality threshold.

9. The first apparatus of claim 7, wherein the one or more measurements are performed in a non-connected state of the first apparatus, and the first apparatus is caused to:
in accordance with a determination that time periods of the one or more measurements time periods are equal to or longer than an evaluation time period, evaluate the reference signal quality based on the one or more measurements and the signal quality threshold.

10. The first apparatus of claim 7, wherein a predetermined threshold offset is absent in requirement information for the first apparatus, and the first apparatus is caused to:
determine a threshold offset autonomously; and
determine the signal quality threshold by applying the determined threshold offset to a reference threshold for a reference signal measurement.

11. The first apparatus of claim 7, wherein the first apparatus is further caused to:
determine the signal quality threshold based on a threshold offset and a reference threshold for a reference signal measurement.

12. The first apparatus of claim 1, wherein the first apparatus is further caused to:
receive, from the second apparatus, configuration information indicating separate signal quality thresholds for different types of SDT; and
determine the signal quality threshold based on the configuration information and a type of the SDT.

13. A method comprising:
disabling, during monitoring a low power wake up signal from a second apparatus, evaluation of a signal quality threshold for a small data transmission, SDT to the second apparatus.
in response to exiting the monitoring of the low power wake up signal, enabling one or more measurements on a reference signal from the second apparatus.
evaluating a reference signal quality of the reference signal based on the one or more measurements and a signal quality threshold.
based on that the reference signal quality meets a condition associated with the signal quality threshold, initiating the SDT to the second apparatus

14. A first apparatus comprising:
means for disabling, during monitoring a low power wake up signal from a second apparatus, evaluation of a signal quality threshold for a small data transmission, SDT to the second apparatus;
means for in response to exiting the monitoring of the low power wake up signal, enabling one or more measurements on a reference signal from the second apparatus;
means for evaluating a reference signal quality of the reference signal based on the one or more measurements and a signal quality threshold; and
means for based on that the reference signal quality meets a condition associated with the signal quality threshold, initiating the SDT to the second apparatus.

15. A computer readable medium comprising instructions stored thereon for causing an apparatus at least to perform the method of claim 13.
